(19) United States
(12) Patent Application Publication
(10) Pub. No.: US 2024/0061274 A1
(43) Pub. Date: Feb. 22, 2024

(54) EYE GLASSES TO ALLEVIATE MOTION SICKNESS

(71) Applicant: Smooth Sees LLC, Wilmette, IL (US)

(72) Inventor: FRANK J. CHESWICK, Wilmette, IL (US)

(21) Appl. No.: 18/030,646

(22) PCT Filed: Jul. 28, 2022
(86) PCT No.: PCT/US22/38642

§ 371 Date: Apr. 6, 2023

Related U.S. Application Data
(60) Provisional application No. 63/247,930, filed on Sep. 24, 2021.
(60) Provisional application No. 63/226,818, filed on Jul. 29, 2021.

(51) Int. Cl. G02C 7/16; G02C 9/00

(52) U.S. Cl. CPC G02C 7/16; G02C 9/00; G02C 2202/10

(57) ABSTRACT

Eye glasses to alleviate the symptoms of motion sickness comprise lenses having parallel, horizontal, spaced-apart lines, hi another embodiment, the lenses have an upper section, a middle or focusing section, and a lower section. The upper section and the lower section are each one of opaque, translucent, and transparent. The middle section is transparent or is translucent to a higher degree than the lower section.

### CROSS REFERENCE TO RELATED APPLICATIONS

This application claims the benefit of U.S. Provisional Patent Application No. 63/247,930, filed on Sep. 24, 2021, and of U.S. Provisional Patent Application No. 63/226,818, filed on Jul. 29, 2021, the disclosures of both of which are incorporated by reference herein for all purposes.

### BACKGROUND OF THE INVENTION

The present invention relates to the use of special eye glasses to alleviate motion sickness. Motion sickness occurs when a person perceives a difference between actual and expected motion. Mismatches happen between a person's integrated pattern of sensory information under real motion (e.g., in boats, cars, and airplanes) or virtual environment (e.g., watching 3D video films or games) and the anticipated motion (neural mismatch or sensory conflict), leading to motion sickness symptoms.

Motion sickness arises from travel in a motor vehicle (car sickness), from air travel (air sickness), or from travel in a boat (sea sickness), as well as from other occasions. For example, the rocking or swaying motion of a vessel in which one is traveling on a large body of water, such as an ocean or large lake, induces sea sickness in some people. The most common symptoms are nausea and vomiting, but can also include cold sweat, headache, sleepiness, yawning, loss of appetite, and increased salivation.

Traditional remedies for motion sickness include taking ginger or peppermint. Other natural remedies include aromatherapy, acupuncture, and acupressure. Pharmacological remedies include antimuscarinics such as scopolamine, H1 antihistamines such as dimenhydrinate, and amphetamines such as dexamphetamine. Pharmacotherapy can have side effects and may be contra-indicated for pregnancy or other risk factors. Additionally, a person suddenly discovering a susceptibility to motion sickness, such as when traveling on a boat, may not have either natural or pharmacological remedies available.

There are numerous non-pharmacological treatment methods. One such method is the behavior management technique of keeping the head still and focusing on the horizon. Maintaining this focus can be difficult for some persons.

### SUMMARY OF THE INVENTION

The present application discloses a novel type of eye glasses uniquely-designed to aid the wearer in focusing on the horizon. In one embodiment, the surface of the lenses of the eye glasses is etched to provide parallel, horizontal lines to help the wearer keep the horizon in focus. In another embodiment, the upper and lower sections of the lenses transmit less light than the middle, focusing section of the lenses, to help the wearer keep the horizon in focus. A tight space defined by the parallel lines or the middle space allows the wearer to contain the view of the horizon, and minimize motion sickness, by making regular minor adjustments of slightly moving the head while keeping the horizon between the bars. The lines help block wave action from the wearer's vision, while allowing the wearer to see enough to remain able to move about.

### A BRIEF DESCRIPTION OF THE DRAWINGS

The organization and manner of the structure and operation of the invention, together with further objects and advantages thereof, may best be understood by reference to the following description, taken in connection with the accompanying non-scale drawings.

FIG. 1 is a front view of the eye glasses of the preferred embodiment of the invention.

FIG. 2 is a front view of the eye glasses of a second embodiment of the invention.

FIG. 3 is a front view of the eye glasses of a third embodiment of the invention.

FIG. 4 is a perspective view of yet another embodiment of the invention.

FIGS. 5A and 5B are views of a backing structure to hold the strips of FIG. 4.

FIG. 6 is a perspective view of another embodiment of a backing structure to hold the strips of FIG. 4.

### DETAILED DESCRIPTION OF THE PREFERRED EMBODIMENTS OF THE INVENTION

A person having symptoms of motions sickness, such as from traveling at sea, is advised to keep focus on the horizon. Maintaining this focus is difficult. The eye glasses of the present invention will help the wearer focus on the horizon and thereby alleviate the symptoms of motion sickness.

The present invention will be described for conventional eye glasses. The frames of the eye glasses are conventional. The lenses of the eye glasses of the present invention may be made of a polymeric plastic, polycarbonate, high-index plastic, glass, or any other material known in the art.

The lenses may be prescription lenses or non-prescription lenses. An individual who has frequent motion sickness may have individual eye glasses with lenses ground to a personal prescription, with a single vision lenses, or may have bifocals, trifocals, or progressive lenses. An operator of a boat such as a ferry, tour boat, or cruise ship, on the other hand, may keep a supply of non-prescription eye glasses available for passengers who are unexpectedly sea sick.

The lenses of the eye glasses of the present invention may in whole or in part be tinted, clear, or photochromic adaptive. Tinted lenses may be lightly tinted or heavily tinted or may have varying degrees of tint. The lenses may have other conventional lens treatments such as scratch resistance, anti-glare, UV protection, polarization, or mirroring.

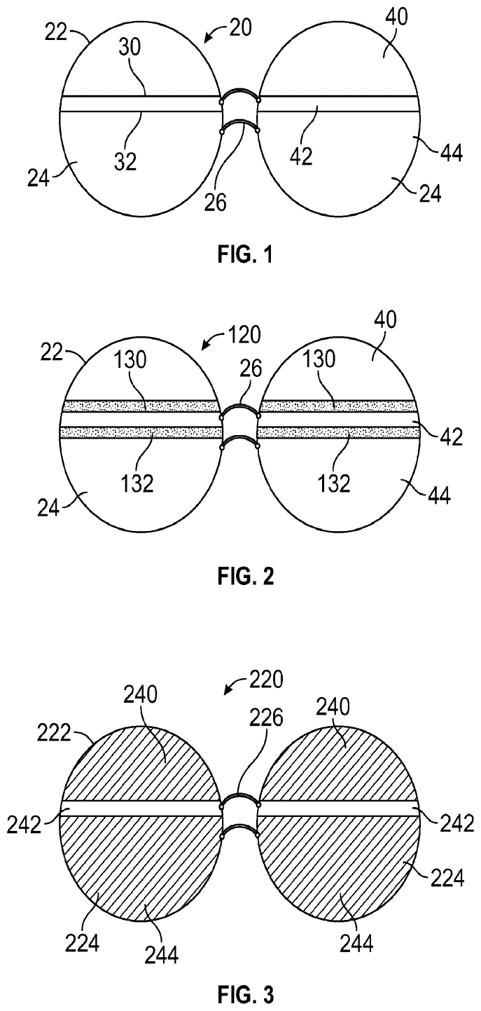

The eye glasses 20 of the preferred embodiment of the invention are shown in FIG. 1. Eye glasses 20 comprise a frame 22, two lenses 24, and a bridge 26. Eye glasses 20 preferably include temples (not shown) attached to frame 22 by hinges, but could instead use an elastic strap as with goggles. Frame 22 usually includes either integral nose pads (not shown) or external nose pads (not shown) attached to frame 22.

In the preferred embodiment, as shown in FIG. 1, a single horizontal upper line 30 and a single horizontal lower line 32, parallel, or at least approximately parallel, to line 30, are etched into both lenses 24. Lines 30, 32 are etched into lenses 24 by laser, rotary tool, etching cream, or any other way known in the art. Alternatively, lines 30, 32 can be applied by a printer, such as a UV LED printer. Lines 30, 32 can also be applied in some other manner to lenses 24.

Lines 30, 32 are preferably very thin, approximately 0.5 millimeter (mm). Lines 30, 32 are spaced a short distance apart. In one embodiment, lines 30, 32 are spaced approximately 0.25 inch (0.635 mm) apart. In other embodiments, the spacing is smaller or larger. Preferably, the distance is 0.5 to three mm.

Lines 30, 32 preferably span the entire width of lenses 24, as shown in FIG. 1. In other embodiments, lines 30, 32 span only a portion of the width of lenses 24. Line 30 defines the lower boundary of an upper section 40 comprising the surface of all of each lens 24 above line 30. Lines 30, 32 define a focusing section 42 comprising the surface of each lens 24 between lines 30, 32. Line 32 defines a lower section 44 comprising the surface of all of each of lens 24 below line 32.

In use, a wearer of eye glasses 20 looks at the horizon and keeps the horizon between lines 30, 32. By maintaining focus on the horizon between these lines, the symptoms of motion sickness will be alleviated or eliminated.

A second embodiment of the present invention is shown in FIG. 2. Eye glasses 120 are identical to eye glasses 20 of the first embodiment, except having thicker lines. Lines 130, 132 preferably span the entire width of lenses 24, as shown in FIG. 1. In other embodiments, lines 130, 132 span only a portion of the width of lenses 24. Line 130 defines the lower boundary of an upper section 40 comprising the surface of all of each lens 24 above line 130. Lines 130, 132 define a focusing section 42 comprising the surface of each lens 24 between lines 130, 132. Line 132 defines a lower section 44 comprising the surface of all of each of lens 24 below line 132.

In eye glasses 120, lines 130, 132 are preferably approximately three mm thick. In other embodiments, lines 130, 132 are larger or smaller.

In use, a wearer of eye glasses 120 looks at the horizon and keeps the horizon between lines 130, 132. By maintaining focus on the horizon between these lines, the symptoms of motion sickness will be alleviated or eliminated.

A third embodiment of the present invention is shown in FIG. 3. Eye glasses 220 comprise a frame 222, two lenses 224, and a bridge 226. Eye glasses 220 usually include temples (not shown) attached to frame 222 by hinges, but could instead use an elastic strap as with goggles. Frame 222 usually includes either integral nose pads (not shown) or external nose pads (not shown) attached to frame 222.

Each lens 224 has three sections, an upper section 240, a middle or focusing section 242, and a lower section 244. Focusing section 242 is a generally rectangular section preferably spanning the entire width of each lens 224. The lower border of focusing section 242 is preferably located at about the midpoint of the maximum height of each lens 224. The width of each focusing section 242, from upper section 240 to lower section 244, is preferably approximately five mm. In other embodiments, the width of focusing section 242 is larger or smaller, preferably 0.5 to three mm. Focusing section 242 is preferably transparent.

Upper section 240 is the entire portion of each lens 224 above focusing section 242. Lower section 244 is the entire portion of each lens 224 below focusing section 242.

Upper section 240 and lower section 244, in this embodiment, are designed to block all or a portion of light from transmission. In one embodiment, both sections 240, 244 are opaque or almost opaque, allowing little or no light to transmit through those sections. In another embodiment, sections 240, 242 are translucent, allowing some but not all light to transmit, a result achieved, by comparison, with lenses of conventional sun glasses. Sections 240, 244 may be frosted or tinted in this embodiment. The tinting or frosting may be adjusted to allow for high translucence or low translucence. Sections 240, 242 may have the same degree of translucence, or section 240 may be more or less heavily tinted than section 240.

In yet another embodiment, focusing section 242 is translucent, allowing some but not all light to transmit. In this embodiment, sections 240, 244 are either opaque or are also translucent but much more so than focusing section 242. For example, focusing section 242 may be lightly tinted and each of sections 240, 244 is heavily tinted or opaque.

Please note that the various sections of the eye glasses of the present invention may have identical or different light transmission capabilities. Here are some examples, set forth for illustration purposes and not as limitations on the invention:
a. All three sections 40, 42, 44 are transparent (with lines 30, 32 as shown in FIG. 1 or lines 130, 132 as shown in FIG. 2).
b. All three sections 40, 42, 44 are translucent (with lines 30, 32 as shown in FIG. 1 or lines 130, 132 as shown in FIG. 2).
c. All three sections 240, 242, 244 are translucent but focusing section 242 is less translucent than sections 240 or 244.
d. Lower section 244 is translucent, upper section 240 is translucent, and focusing section 242 is transparent.
e. Lower section 244 is translucent, focusing section 242 and upper section 244 are transparent (with upper line 30).
f. Lower section 244 is opaque, upper section 240 is opaque, and focusing section 242 is transparent or translucent.
g. Lower section 244 is opaque, upper section 240 is translucent, and focusing section 242 is transparent.
h. Lower section 244 is opaque, upper section 240 and focusing section 242 are translucent (with upper line 30).
i. Lower section 244 is opaque, upper section 240 is translucent, and focusing section 242 is translucent but to a lesser degree than section 240.

In the embodiment shown in FIGS. 1 and 2, each of sections 40, 42, 44 may have the same light transmission capability. In the embodiment shown in FIG. 3, each of sections 240, 242, 244 may have different light transmission capabilities, so long as focusing section 242 allows more light to transmit than at least lower section 244.

In yet another embodiment, however, upper section 240 and focusing section 242 may both be transparent or upper section 240 and focusing section 242 may each have the same degree of translucence, essentially merging the two sections. In this embodiment, lower section 244 is opaque or has a lower degree of translucence.

In use, a wearer of eye glasses 220 looks at the horizon and keeps the horizon within focusing section 242. By maintaining focus on the horizon within this section, the symptoms of motion sickness will be alleviated or eliminated.

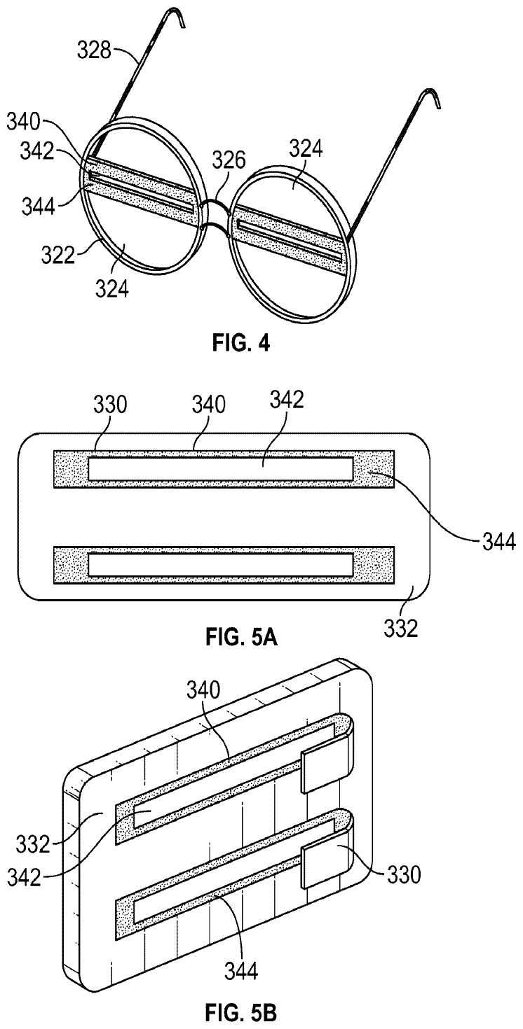

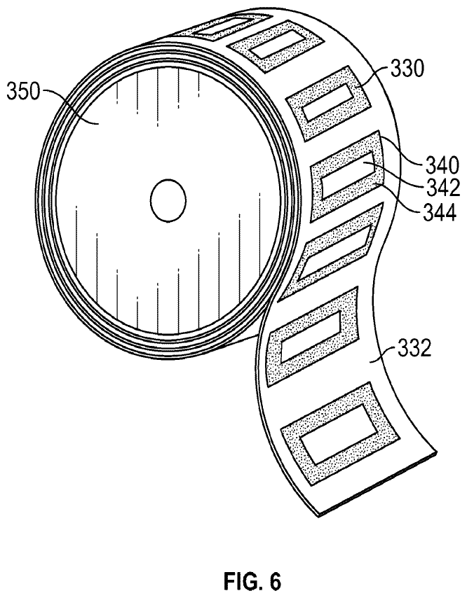

Yet another embodiment of the present invention is shown in FIGS. 4, 5A, and 5B. Eye glasses 320 comprise a frame 322, two lenses 324, and a bridge 326. Eye glasses 320 usually include temples 328 attached to frame 322 by hinges, but could instead use an elastic strap as with goggles. Frame 322 usually includes either integral nose pads (not shown) or external nose pads (not shown) attached to frame 322.

Disposable adhesive strips 330 are made of a flexible film. Strips 330 are preferably supplied on a nonadhesive backing 332, as shown in FIGS. 5A, from which strips 330 are shown unpeeled, and in FIG. 5B, in which strips 330 are shown partially peeled.

Strips 330 can also be supplied with nonadhesive backing 332 formed as a roll 350, as shown in FIG. 6. Roll 350 may have perforations between each strip 330 for easy removal from roll 350. Strips 330 may be crosswise on roll 350, as shown in FIG. 6, or may be arranged longitudinally.

A user peels a disposable strip 330 from backing 332 and applies disposable strip 330 to a lens 324.

Each strip 330 has an upper section 340, a focusing section 342, and a lower section 344. Focusing section 342 may be cut out from strip 330, forming an aperture in strip 330, or strip 330 may be integral. Focusing section 343 is preferably one mm to four mm in width, more preferably 0.5 to three mm.

Upper section 340 and lower section 344 are preferably opaque but can also be translucent. In one embodiment, upper section 340 and lower section 344 are opaque and focusing section 342 is translucent. In another embodiment, upper section 340 and lower section 344 are translucent and focusing section is transparent. In yet another embodiment, upper section 340 and lower section 344 are opaque or translucent and focusing section 342 comprises an aperture through strip 330.

Strips 330 preferably comprise a clear static cling vinyl film. In another embodiment, strips 330 comprise a self-healing, flexible, thermoplastic urethane film. Strips 330 can be self-adhesive to glass or plastic lenses or can have an adhesive for this purpose.

Strips 330 preferably span the entire width of lenses 324. In other embodiments, strips 330 span only a portion of the width of lenses 324.

In use, a wearer of eye glasses 320 looks at the horizon and keeps the horizon within focusing section 342. By maintaining focus on the horizon between upper section 340 and lower section 344, the symptoms of motion sickness will be alleviated or eliminated.

Preferably, a user dons the eye glasses 20, 120, or 220 of the present invention or applies the strips 330 of the present invention to the user's own eye glasses before noticing the symptoms of motion sickness, to help prevent or at least ameliorate motion sickness. If the user dons the eye glasses or applies the strips after experiencing the symptoms, the use of the eye glasses may alleviate the symptoms.

The eye glasses or strips of the present invention may be distributed by a business in which customers may experience motion sickness, such as an operator of a tour boat, a ferry, or a cruise ship. The eye glasses and strips may be made of disposable materials. The operator may keep a supply of these objects available for passengers, who may then keep the eye glasses as souvenirs or may dispose of them. The eye glasses of the present invention may have the operator's own trademark or trade dress on the frames or lenses of the eye glasses or may sell advertising to third parties. The backing 332 of the present invention may have the operator's trademark, trade dress, or contact information. For example, a ferry boat operator may distribute eye glasses of the present invention to passengers, with frames in the brand colors of the ferry boat operator and the operator's logo etched into the lenses. Or, a ferry boat operator may distribute strips 330 of the present invention to passengers, with upper section 340 and lower section 344 in the brand colors of the ferry boat operator.

While preferred embodiments of the present invention are shown and described, it is envisioned that those skilled in the art may devise various modifications of the present invention without departing from the spirit and scope of the appended claims.

1-12. (canceled)

13. A disposable strip for applying to eye glasses for containing a view of a horizon, the strip comprising an upper section, a middle section, and a lower section, wherein
the upper section is transparent or translucent,
the lower section is transparent or translucent, and
the middle section is transparent,
wherein the middle section has a height and a width, the width being greater than the height.

14. A plurality of the strips of claim 13, applied to a non-adhesive backing.

15. A plurality of the strips of claim 13, wherein the plurality of strips comprises a thermoplastic urethane film.

16. The plurality of the strips of claim 14, wherein the non-adhesive backing comprises a roll.

17. The plurality of the strips of claim 16, wherein the plurality of strips comprises a thermoplastic urethane film.

18. The strip of claim 13, further comprising advertising.
